(19) United States
(12) Patent Application Publication
(10) Pub. No.: US 2014/0190699 A1
(43) Pub. Date: Jul. 10, 2014

(54) Recovery of Oil

(71) Applicants: Philip Fletcher, Bradford (GB); Jeffrey Forsyth, Calgary (CA); Cory Jaska, Toronto (CA)

(72) Inventors: Philip Fletcher, Bradford (GB); Jeffrey Forsyth, Calgary (CA); Cory Jaska, Toronto (CA)

(73) Assignee: OILFLOW SOLUTIONS HOLDINGS LIMITED, Wigan, Lancashire (GB)

(21) Appl. No.: 14/236,120

(22) PCT Filed: Jul. 23, 2012
(86) PCT No.: PCT/GB2012/051762

§ 371 Date: Mar. 18, 2014

(30) Foreign Application Priority Data
Aug. 1, 2011 (GB) 1113229.7

(51) Int. Cl. C09K 8/588; E21B 43/16

(52) U.S. Cl. CPC C09K 8/588; E21B 43/16
USPC 166/305.1; 166/162; 507/225

(57) ABSTRACT

A treatment formulation for use in enhanced oil recovery is described which includes a dispersing polymer which may be a partly hydrolyzed polyvinyl alcohol and a displacing polymer which may be a partially hydrolysed polyacrylamide.

This invention relates to oil recovery and particularly, although not exclusively, relates to recovery of medium and heavy oils (including bitumen) from subterranean formations.

The amount of oil that is recoverable from a reservoir formation is determined by a number of factors. These include the formation permeability, the porosity of the formation, reservoir heterogeneities and the strength of natural drives (free gas, gas dissolved in the oil, pressure from adjacent water or gravity etc). The viscosity of the oil is also a major factor in determining the magnitude and rate of oil production, as is its density; lower density oils tend to yield higher extraction rates.

Typically, oil is extracted from subterranean formations, in one or all of three sequential phases, during the lifetime of a reservoir. The effectiveness of extraction in any phase is quantified using the recovery factor, which is simply the oil removed, expressed as a percentage of the original oil in place.

During the primary recovery stage, reservoir drive comes from a number of natural mechanisms that exploit the fact that the underground pressure in the reservoir is sufficient to force the oil to the surface. The recovery factor during the primary recovery stage is typically between 5% and 20%, although for low API oils it may be much lower.

The next stage is the secondary recovery phase. This normally begins at a point in the lifetime of the reservoir when the underground pressure has depleted to a level where it is insufficient to drive the oil to the surface. Secondary recovery methods rely on the supply of external energy to drive the oil to the surface. Energy can be supplied directly to the reservoir by injecting fluids into the reservoir to increase its drive pressure, thus replacing or increasing the natural reservoir drive with an artificial drive. Injected fluids include water, brine or natural gas. Alternatively, energy can be supplied at the producing sandface via pumps, or into the wellbore, to help lift the oil to the surface (artificial lift); although, it should be noted that artificial lift can be used in any production phase and is not only a secondary recovery technique. On average, the recovery factor after primary and secondary oil recovery is between 20% and 50%, and depends on the properties of the oil and the characteristics of the reservoir rock. Waterflooding, via the injection of water or brine into the reservoir, is the most important oil recovery method beyond primary recovery.

The third sequential phase is the tertiary recovery phase, which normally begins when secondary oil recovery is not enough to continue adequate extraction. Tertiary recovery is often called Enhanced Oil Recovery (EOR). Tertiary recovery involves increasing the mobility of the oil in the pore space of the reservoir rock itself, as opposed to simply supplying extra energy. Commonly, this involves the direct injection of chemical modifiers into the reservoir. Chemical modifiers are often water based and contain surfactants to liberate oil from rock, or polymers to increase the water viscosity and improve the efficiency at which oil is ‘pushed’ through the formation. Other modifiers or additives include diluents, alkalis, super-critical gases, microbes or steam.

Tertiary recovery allows a further 5% to 15% of the reservoir's oil to be produced. This incremental increase may be as high as 35% with steam injection. However, the use of chemicals, or the provision of energy to produce steam, increases costs. The use of tertiary recovery is therefore highly dependent on the oil price and the effectiveness of the process. When the oil price is high, previously unprofitable wells are brought back into use with tertiary recovery, and when the oil price is low tertiary extraction is curtailed.

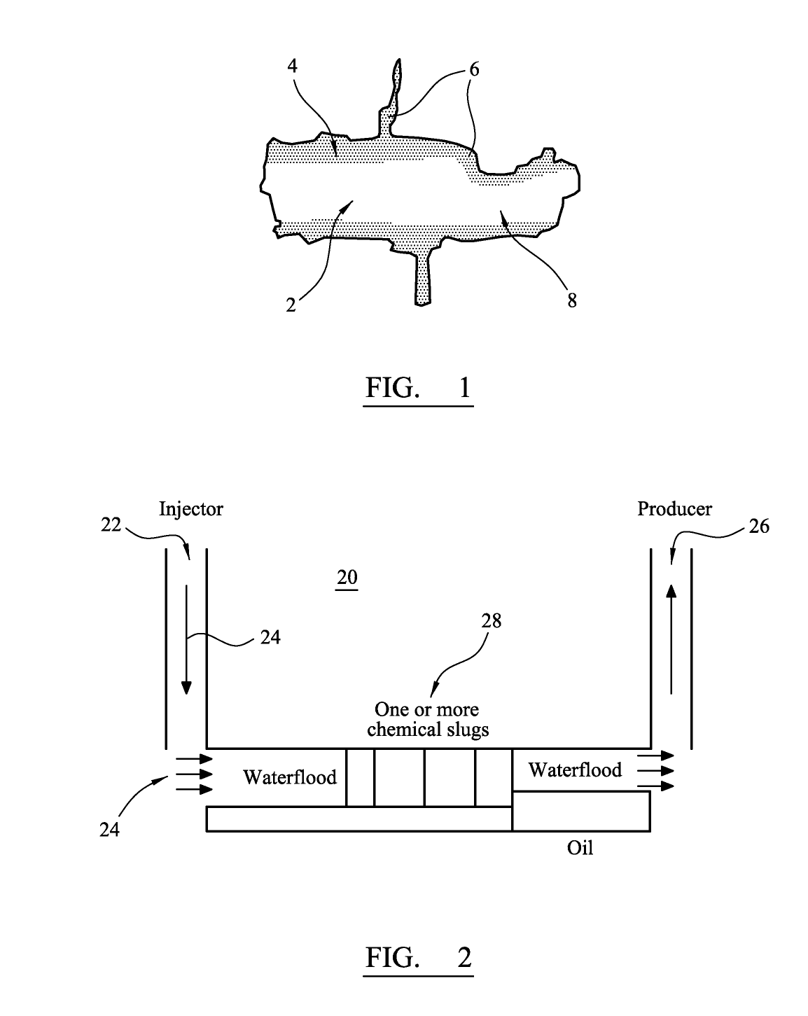

Conventional wisdom states that oil left in reservoir pores, after primary or secondary recovery, is distributed through three locations. Referring to FIG. 1, the largest proportion of oil 2 resides in the wider ‘gaps’ in pores and is considered to be the most mobile oil fraction. Secondly, a smaller proportion of oil 4 is considered to be adsorbed strongly to pore surfaces through short range interfacial forces. Thirdly, some oil 6 is considered to be trapped mechanically, or bound by capillary forces, in microcracks and in irregular cavities close to pore throats 8. Oil in the latter two categories is grouped together, termed irreducible oil, and considered to be inaccessible or very difficult to displace.

Conventionally, three characteristics regulate the recovery factor in the tertiary recovery phase:

1. The Sweep Efficiency and Mobility Ratio: The sweep efficiency is a measure of how evenly a displacing fluid has moved through the available space in a porous medium. If the sweep efficiency is increased, the recovery factor is increased correspondingly. Conceptually, the sweep efficiency is maximized if, when oil is displaced, it is ‘banked’ ahead of the displacing fluid. In contrast, this macroscopic effect is minimized if the displacing fluid breaks through or around the oil. The sweep efficiency is itself maximized when the mobility ratio (M) is minimized. The mobility ratio M is defined as the ratio of the mobility of the displacing fluid (λ ing) to that of the displaced fluid (λ ed), where the mobility of any fluid in a porous medium (λ, in Darcies/cP), is the ratio of effective permeability of the fluid (k in Darcies) to the viscosity of the fluid (μ in cP) (Craig 1971, Green and Willhite 1998), i.e.

$$M = \frac{{λ}_{ing}}{{λ}_{ed}} = \frac{\frac{{k}_{ing}}{{μ}_{ing}}}{\frac{{k}_{ed}}{{μ}_{ed}}}$$

The sweep efficiency is an important element influencing the value of an EOR intervention, but it is only one factor in the overall economic optimization. For example, achieving a sweep efficiency of over 90% may require the use of an inordinate amount of chemical, thus offsetting the benefit of any extra produced oil. Sweep efficiencies for light oils are often above 80%, but with heavy oils only 50% may be achievable. To achieve optimal sweep efficiencies, the mobility ratio (M) must be less than 10, preferably less than 2, most preferably less than 0.5.

2. The Sweep Efficiency and Viscous Instabilities (viscous fingering): In addition to phenomena related to the mobility ratio, there is another mechanism that can lead to a reduction of the sweep efficiency. This mechanism is associated with small-scale viscous instabilities in the displacement front. It can develop in the most homogeneous of porous media and arises from small perturbations in an otherwise uniform flow pattern. These perturbations may be caused, for example, by small differences in the shape of grains or pores. Microscopic viscous fingers are likely to form that will result in the bypassing and trapping of oil on quite a large scale. Viscous fingers created by this mechanism are likely to be formed at relatively low flow rates. The magnitude of this problem increases as the difference between the viscosities of the displacing and the displaced fluid increases and the effect will be more pronounced the more viscous is the oil.

3. The Displacement Efficiency: This is a measure of the ability of a displacing fluid to release oil from microscopic regions of porespace where oil is trapped by interfacial forces.

In general terms, it is an object of the invention to facilitate and/or improve the recovery of oil from subterranean formations.

It is an object of the preferred embodiments of the invention to improve the mobility ratio.

It is an object of preferred embodiments of the invention to reduce viscous fingering.

It is also an object of preferred embodiments of the invention to improve displacement efficiency.

According to a first aspect of the invention, there is provided a method of recovering oil from a subterranean formation, the method including the step of:

(a) contacting the subterranean formation with a treatment formulation comprising a displacing polymer and a dispersing polymer; and

(b) collecting oil which has been contacted with said treatment formulation via a production well.

Said treatment formulation is preferably an aqueous formulation. Said displacing polymer is preferably arranged to increase the viscosity of water with which it is associated. Said displacing polymer is preferably such that a test formulation comprising 500 ppm of said displacing polymer dissolved in deionized water (in the absence of any other additives, for example, in the absence of said dispersing polymer) has a viscosity when measured at 25° C. and 1 s⁻¹ in the range 5 cP to 100 cP, preferably in the range 10 cP to 35 cP. Suitably, the displacing polymer generates a desired increase in viscosity at higher temperatures as may be found in oil in subterranean formations. Suitably, the following first relationship applies, when viscosity is measured as aforesaid:

$$\frac{Viscosity of test formulation at {30}^{∘} C}{Viscosity of test formulation at {20}^{∘} C} >= 0.6$$

Preferably, the following second relationship applies, when the viscosity is measured as aforesaid:

$$\frac{Viscosity of test formulation at {80}^{∘} C}{Viscosity of test formulation at {20}^{∘} C} >= 0.10$$

Said first relationship is preferably greater or equal to 0.7 or 0.8. Said second relationship may be greater or equal to 0.15, 0.20 or 0.24.

Said viscosity of said test formulation, when measured as aforesaid, at 80° C. is preferably at least 4 cP, more preferably at least 6 cP.

The dispersing polymer is suitably selected so as not to significantly affect the viscosity of the formulation and/or the viscosifying effect due to inclusion of said displacing polymer. Thus, suitably the viscosity of the treatment formulation divided by the viscosity of a formulation that is the same as said treatment formulation except that it does not include the dispersing polymer, when the viscosities are measured at 25° C. and 1 s⁻¹, is suitably in the range 0.6 to 1.3, preferably 0.8 to 1.2, more preferably 0.9 to 1.1.

Said displacing polymer is suitably soluble in water and/or is dissolved in water in the treatment formulation. Said displacing polymer suitably exhibits Non-Newtonian characteristics when provided in an aqueous formulation, suitably at the concentration used in said treatment formulation.

Said displacing polymer may have a molecular weight of at least 200,000 Daltons, suitably at least 500,000 Daltons, preferably at least 1,000,000 Daltons, more preferably at least 2,000,000 Daltons. The molecular weight may be less than 35,000,000 Daltons or less than 25,000,000. Molecular weight may be measured by Measurement of Intrinsic Viscosity (see ISO 1628/1-1984-11-01); and using Intrinsic Viscosity/Molecular Weight Correlation via Mark-Houwink Equation. Polymers of the aforementioned molecular weights can undergo a process of self-assembly or self-organization to form an organized matrix or network out of a previously disordered system. Network formation leads to a solution of the polymer having a higher viscosity than the water alone. In some cases, the network formation may be facilitated by use of cross-linkers.

Preferably, said displacing polymer is sufficiently stable against high shearing forces, variations in pH or the presence of polyvalent metallic ions. It preferably exhibits non-Newtonian flow behaviour when in solution and is relatively durable under high temperatures as may be experienced in subterranean formations.

Said displacing polymer may have a degradation temperature of greater than 80° C., preferably greater than 100° C.

Said displacing polymer preferably displays pseudoplastic characteristics and/or viscoelasticity when in said treatment formulation.

Said displacing polymer may be a natural or synthetic polymer. Natural polymers may be made by fermentation processes. Said displacing polymer may be a polysaccharide or a biopolymer or a derivative (e.g. a synthetic derivative such as a cross-linked derivative of any of the aforesaid). Said displacing polymer may be a gum. Said displacing polymer may be selected from xanthan gum, scleroglucan, chitin and diutan. Said displacing polymer may be a derivative of any of the aforesaid. Said displacing polymer preferably includes a repeat unit which includes a —CH₂CHR*-, wherein R* is a pendent group.

Said displacing polymer may be selected from poly(vinylalcohol), acrylic acid-based, acrylamide-based and vinylpyridine-based polymers, poly(methylvinylether), polyvinylpyrrolidone, polyethylene oxide, cellulose, polysaccharides, biopolymers, scleroglucan, xanthan and derivatives of the aforesaid.

Said displacing polymer may include a functional group in a repeat unit selected from amide, carboxy, hydroxy and ether groups. Said displacing polymer may include at least two different repeat units, wherein suitably both said at least two different repeat units include functional groups selected from amide, carboxy, hydroxy and ether groups.

Said displacing polymer preferably includes a repeat unit which includes an acrylamide for example of formula

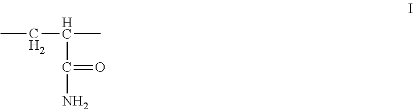

On average, the ratio of the number of other repeat units in the displacing polymer divided by the number of repeat units of formula I may be less than 0.6, 0.5, 0.4, 0.3 or 0.2. Said ratio may be at least 0.0025, at least 0.005, at least 0.05 or at least 0.1

Said displacing polymer may include a repeat unit of formula I in combination with a repeat unit comprising a moiety

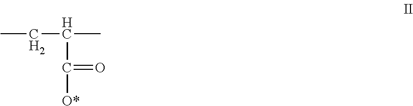

wherein the O* moiety is an O⁻ moiety or is covalently bonded to another atom or group.

Said displacing polymer may include a repeat unit of formula I in combination with a repeat unit comprising a moiety

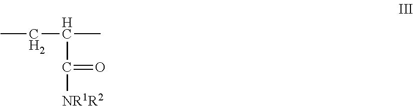

wherein R¹ and R² are independently selected from a hydrogen atom and an optionally-substituted alkyl group. An optionally-substituted alkyl group may define an electrically neutral hydrophobe. An optionally-substituted alkyl group may incorporate an —SO₃R³ moiety wherein R³ is selected from a hydrogen atom and a cationic moiety, for example an alkali metal cation, especially Na⁺. Said optionally-substituted alkyl group may include 1 to 10 carbon atoms.

Said moiety III may be of formula

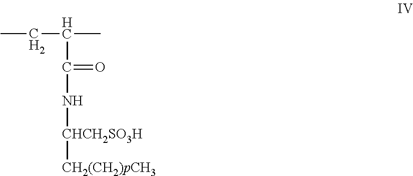

wherein p is an integer in the range 0 to 10, suitably 0 to 5;

or said moiety III may be of formula

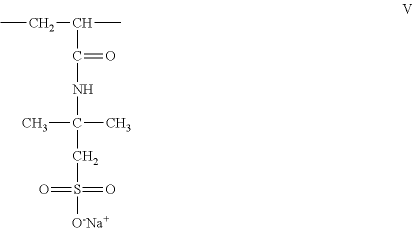

In one embodiment, said displacing polymer may be a hydrophobically modified polyacrylamide, for example comprising a first repeat unit of formula III wherein R¹ and R² represent hydrogen atoms in combination with a second repeat unit of formula III wherein R¹ represents a hydrogen atom and R² represents an alkyl group substituted with a —SO₃H moiety or —SO₃Na⁺ moiety. In another embodiment, said displacing polymer may be an acrylamidomethyl propane sulphonate (AMPS). In an embodiment wherein said second repeat unit is substituted with a —SO₃H moiety, said first and second repeat units may be in combination with a third repeat unit of formula III wherein the O* moiety is bonded to a hydrogen atom. Displacing polymers may be of formula

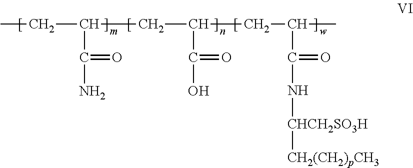

wherein m, n and w represent the average number of respective repeat units and p is as described above; or of formula

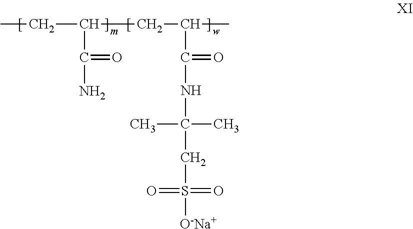

Said displacing polymer may be a hydrophobically-modified acrylamide (otherwise known as a hydrophobically associating polymer), for example of formula V. In such a polymer, the ratio of the number of other repeat units divided by the number of repeat units of formula I may be at least 0.0025 and, suitably is less than 0.045.

Preferably, said displacing polymer comprises, preferably consists essentially of, repeat units I and II. Preferably, said displacing polymer is a partially hydrolysed acrylamide. It may be of formula

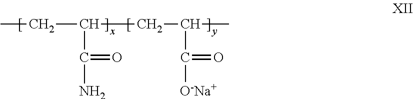

Preferably, 100y/(x+y) is in the range 20 to 30. The polymer may have a molecular weight measured as aforesaid of 18 million Daltons to 22 million Daltons. It may have a degree of hydrolysis of 20 to 30%. It is preferably a block copolymer.

Said treatment formulation may include less than 8000 ppm, suitably less than 4000 ppm, preferably less than 1000 ppm, more preferably less than 500 ppm of said displacing polymer.

Said treatment formulation may include at least 25 ppm, suitably at least 50 ppm, preferably at least 75 ppm, more preferably at least 100 ppm of said displacing polymer.

Said dispersing polymer is preferably arranged to disperse oil in the subterranean formation and simultaneously modify interfacial characteristics.

Said dispersing polymer preferably has one or more (preferably each) of the following properties/features:
Be soluble and permanently stable in the aqueous formulation, in the presence or absence of the displacing polymer.
An aqueous solution containing the dispersing polymer should be capable of dispersing oil, if said oil is blended into the aqueous solution, in the presence or absence of the displacing polymer.
Oil dispersions comprising oil from the subterranean formation and an aqueous formulation of dispersing polymer (containing 5000 ppm of dispersing polymer), at an oil:aqueous formulation ratio of 70:30, preferably have the following characteristics at 25° C.
   viscosities, at a shear rate of 1 s⁻¹, of less than 4000 cP, preferably less than 3000 cP, most preferably less than 2000 cP.
   be pseudoplastic over the shear rate range 1 s⁻¹ to 100 s⁻¹.
   have viscosities, at a shear rate of 100 s⁻¹, of no more than 600 cP, preferably less than 400 cP, most preferably less than 300 cP.
Oil dispersions comprising oil from the subterranean formation, dispersing polymer and displacing polymer, at an oil:aqueous formulation fluid ratio of 70:30, preferably have the following characteristics:
   viscosities, at a shear rate of 1 s⁻¹, of less than 5000 cP, preferably less than 4000 cP, most preferably less than 3000 cP.
   be pseudoplastic over the shear rate range 1 s⁻¹ to 100 s⁻¹.
   have viscosities, at a shear rate of 100 s⁻¹, of no more than 700 cP, preferably less than 500 cP, most preferably less than 400 cP.
An aqueous solution comprising 5000 ppm of the dispersing polymer, in the presence or absence of the displacing polymer (at the concentration used in contacting the subterranean formation), preferably has a maximum surface tension of 56 mN/m at 25° C.
An aqueous solution comprising 5000 ppm of the dispersing polymer, in contact with oil from the subterranean formation, preferably has a maximum interfacial tension of 15 mN/m, preferably 10 mN/m, most preferably 8 mN/m.
The dispersing polymer is preferably capable of water wetting the pore linings and displacing attached oil.

Said dispersing polymer is preferably non-ionic.

The viscosity of an aqueous solution and/or formulation as described herein may be assessed by Japanese Standards Association (JSA) JIS K6726 using a Type B viscometer, an Anton Paar MCR 300 or a Brookfield type viscometer.

Said dispersing polymer may be selected from polyacrylic acid, acrylic acid, hydroxypropylmethyl cellulose, carboxymethyl cellulose, polyvinyl alcohol and copolymers of the aforesaid. The dispersing polymer may be cross-linked. However, preferably said dispersing polymer is not cross-linked.

Said dispersing polymer preferably includes —O— moieties pendent from a polymeric backbone. Said polymeric backbone of said dispersing polymer preferably includes carbon atoms. Said carbon atoms are preferably part of —CH₂— moieties. Preferably, a repeat unit of said polymeric backbone includes carbon to carbon bonds, preferably C—C single bonds. Preferably, said dispersing polymer includes a repeat unit which includes a —CH₂— moiety. Preferably, said polymeric backbone does not include any —O— moieties, for example —C—O— moieties such as are found in an alkyleneoxy polymer, such as polyethyleneglycol. Said polymeric backbone is preferably not defined by an aromatic moiety such as a phenyl moiety such as is found in polyethersulphones. Said polymeric backbone preferably does not include any —S— moieties. Said polymeric backbone preferably does not include any nitrogen atoms. Said polymeric backbone preferably consists essentially of carbon atoms, preferably in the form of C—C single bonds.

Said —O— moieties are preferably directly bonded to the polymeric backbone—that is, suitably no intermediate atoms are provided between the backbone and the —O— moieties.

Said dispersing polymer preferably includes, on average, at least 10, more preferably at least 50, —O— moieties pendent from the polymeric backbone thereof. Said —O— moieties are preferably a part of a repeat unit of said dispersing polymer.

Preferably, said —O— moieties are directly bonded to a carbon atom in said polymeric backbone of said dispersing polymer, suitably so that said dispersing polymer includes a moiety (which is preferably part of a repeat unit) of formula:

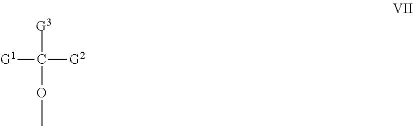

where G¹ and G² are other parts of the polymeric backbone and G³ is another moiety pendent from the polymeric backbone. Preferably, G³ represents a hydrogen atom.

Preferably, said dispersing polymer includes a moiety

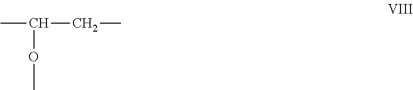

Said moiety VIII is preferably part of a repeat unit. Said moiety VIII may be part of a copolymer which includes a repeat unit which includes a moiety of a different type compared to moiety VIII. Suitably, at least 60 mole %, preferably at least 70 mole %, more preferably at least 80 mole % of said dispersing polymer comprises repeat units which comprise (preferably consist of) moieties VIII. Preferably, said dispersing polymer consists essentially of repeat units which comprise (preferably consist of) moieties VIII.

When said dispersing polymer includes a copolymer which includes units in addition to units VIII, said units may be vinyl units, suitably vinyl units incorporating amine, sulphonic, alkyl or formamide groups.

Said dispersing polymer suitably consists essentially of units of formula VIII and 20 mole % or less, preferably 10 mole % or less, more preferably 5 mole % or less, especially 0 mole % of other units.

Suitably, 60 mole %, preferably 80 mole %, more preferably 90 mole %, especially substantially all of said first polymeric material comprises vinyl moieties.

Preferably, the free bond to the oxygen atom in moieties VII and/or VIII is bonded to a group R¹⁰ (so that the moiety pendent from the polymeric backbone of said dispersing polymer is of formula —O—R¹⁰). Preferably, group R¹⁰ comprises fewer than 10, more preferably fewer than 5, especially 3 or fewer carbon atoms. It preferably only includes atoms selected from carbon, hydrogen and oxygen atoms. R¹⁰ is preferably selected from a hydrogen atom and an alkylcarbonyl, especially a methylcarbonyl group. Preferably moiety —O—R¹⁰ in said dispersing polymer is an hydroxyl or acetate group.

Said dispersing polymer may include a plurality, preferably a multiplicity, of functional groups (which incorporate the —O— moieties described) suitably selected from hydroxyl and acetate groups. Said dispersing polymer preferably includes at least some groups wherein R¹⁰ represents an hydroxyl group. Suitably, at least 30%, preferably at least 50%, especially at least 80% of groups R¹⁰ are hydroxyl groups. Said dispersing polymer preferably includes a multiplicity of hydroxyl groups pendent from said polymeric backbone; and also includes a multiplicity of acetate groups pendent from the polymeric backbone.

The ratio of the number of acetate groups to the number of hydroxyl groups in said dispersing polymer is suitably in the range 0 to 3, is preferably in the range 0.5 to 1, is more preferably in the range 0.06 to 0.3, is especially in the range 0.06 to 0.25.

Preferably, substantially each free bond to the oxygen atoms in —O— moieties pendent from the polymeric backbone in said dispersing polymer, except for any free bonds which are involved in optionally cross-linking the first polymeric material, is of formula —O—R¹⁰ wherein each group —OR¹⁰ is selected from hydroxyl and acetate.

Preferably, said dispersing polymer includes a vinyl alcohol moiety, especially a vinyl alcohol moiety which repeats along the backbone of the dispersing polymer. Said dispersing polymer preferably includes a vinyl acetate moiety, especially a vinylacetate moiety which repeats along the backbone of the dispersing polymer.

Said dispersing polymer suitably comprises at least 50 mole %, preferably at least 60 mole %, more preferably at least 70 mole %, especially at least 80 mole % of vinylalcohol repeat units. It may comprise less than 99 mole %, suitably less than 95 mole %, preferably 92 mole % or less of vinylalcohol repeat units. Said dispersing polymer suitably comprises 60 to 99 mole %, preferably 80 to 95 mole %, more preferably 85 to 95 mole %, especially 80 to 91 mole % of vinylalcohol repeat units.

Said dispersing polymer preferably includes vinylacetate repeat units. It may include at least 2 mole %, preferably at least 5 mole %, more preferably at least 7 mole %, especially at least 9 mole % of vinylacetate repeat units. It may comprise 30 mole % or less, or 20 mole % or less of vinylacetate repeat units. Said dispersing polymer preferably comprises 9 to 20 mole % of vinylacetate repeat units.

Said dispersing polymer is preferably not cross-linked.

Suitably, the sum of the mole % of vinylalcohol and vinylacetate repeat units in said dispersing polymer is at least 70 mole %, preferably at least 80 mole %, more preferably at least 90 mole %, especially at least 99 mole %.

Said dispersing polymer preferably comprises 70 to 95%, more preferably 80 to 95%, especially 85 to 91% hydrolysed polyvinylalcohol.

The weight average molecular weight (Mw) of said dispersing polymer may be less than 500,000, suitably less than 300,000, preferably less than 200,000, more preferably less than 100,000. In an especially preferred embodiment, the weight average molecular weight may be in the range 5,000 to 50,000. The weight average molecular weight of dispersing polymer may be less than 40,000, suitably is less than 30,000, preferably is less than 25,000. The Mw may be at least 5,000, preferably at least 10,000. The Mw is preferably in the range 5,000 to 25,000, more preferably in the range 10,000 to 25,000.

The viscosity of a 4 wt % aqueous solution of the dispersing polymer at 20° C. is preferably in the range 1.5-7 cP.

The viscosity of a said 4 wt % aqueous solution of the dispersing polymer at 20° C. may be at least 2.0 cP, preferably at least 2.5 cP. The viscosity may be less than 6 cP, preferably less than 5 cP, more preferably less than 4 cP. The viscosity is preferably in the range 2 to 4 cP.

The number average molecular weight (Mₙ) of said dispersing polymer may be at least 5,000, preferably at least 10,000, more preferably at least 13,000. Mₙ may be less than 40,000, preferably less than 30,000, more preferably less than 25,000. The Mₙ is preferably in the range 5,000 to 25,000.

Weight average molecular weight may be measured by light scattering, small angle neutron scattering, x-ray scattering or sedimentation velocity. The viscosity of the specified aqueous solution of the first polymeric material may be assessed by Japanese Standards Association (JSA) JIS K6726 using a Type B viscometer. Alternatively, viscosity may be measured using other standard methods. For example, any laboratory rotational viscometer may be used such as an Anton Paar MCR300.

Whilst it is preferred for said dispersing polymer not to be cross-linked (i.e. to comprise a polymeric material which is not cross-linked), when said dispersing polymer is cross-linked, it may comprise a polymeric material formed by reaction of a dispersing polymer described and a second material which includes a functional group which is able to react to cross-link said dispersing polymer and form a third polymeric material.

Formation of said third polymeric material may involve a condensation reaction. Formation of said third polymeric material may involve an acid catalysed reaction.

Said dispersing polymer and second material may include functional groups which are arranged to react, for example to undergo a condensation reaction, thereby to form said third polymeric material. Said dispersing polymer and second material may include functional groups which are arranged to react for example to undergo an acid catalysed reaction thereby to form said third polymeric material.

Said second material may be an aldehyde, carboxylic acid, urea, acroleine, isocyanate, vinyl sulphate or vinyl chloride of a diacid or include any functional group capable of condensing with one or more groups on said dispersing polymer. Examples of the aforementioned include formaldehyde, acetaldehyde, glyoxal and glutaraldehyde, as well as maleic acid, oxalic acid, dimethylurea, polyacroleines, diisocyanates, divinyl sulphate and the chlorides of diacids.

Said second material may be an aldehyde containing or generating compound. Said second material may be an aldehyde containing compound and may include a plurality of aldehyde moieties. Said aldehyde containing compound may be of formula IV as described in WO98/12239, the content of which is incorporated herein for WO2006/106300.

Said treatment formulation used in the method suitably comprises at least 80 wt %, preferably at least 90 wt %, more preferably at least 95 wt %, especially at least 98 wt % water. It may include 99.5 wt % or less of water.

Said treatment formulation used in the method suitably includes at least 0.1 wt %, preferably at least 0.2 wt %, more preferably at least 0.3 wt % of said dispersing polymer. It may include less than 1.5 wt % preferably less than 1 wt %, more preferably less than 0.8 wt % of said dispersing polymer.

Suitably, the treatment formulation includes the following:
100 ppm to 30000 ppm displacing polymer
500 ppm to 10000 ppm displacing polymer
water to balance

In a preferred embodiment, the treatment formulation includes 100 ppm to 1000 ppm displacing polymer and 2000 ppm to 8000 ppm dispersing polymer.

Water for use in the treatment formulation may be derived from any convenient source. It may be potable water, surface water, sea water, aquifer water, deionised production water and filtered water derived from any of the aforementioned sources. Said water is preferably a brine, for example sea water or is derived from a brine such as sea water. The references to the amounts of water herein suitably refer to water inclusive of its components, e.g. naturally occurring components such as found in sea water. Water may include up to 6 wt % dissolved salts but suitably includes less than 4 wt %, 2 wt % or 1 wt % or less of dissolved salts which are naturally occurring in the water. It is preferred for a low salinity water to be used.

In a preferred embodiment, said displacing polymer includes an acrylamide repeat unit and said dispersing polymer includes vinylalcohol and vinylacetate repeat units.

The treatment formulation is suitably arranged to enhance the mobility of oil it contacts. It may achieve this by causing a mass of oil to form droplets which are stabilized by said dispersing polymer. Thus after contact with said treatment formulation, the oil may comprise a dispersion and/or emulsion of oil droplets, suitably in water.

Prior to contact, the subterranean formation may include regions of oil which are separated from one another. For example, oil may be trapped in pores or other hollow regions and separated from other oil trapped in pores or other hollow regions. Preferably, in the method, the treatment formulation is arranged to contact (and suitably enhance the mobility of) oil arranged in at least two (preferably a multiplicity—e.g. over a hundred) spaced apart positions. Thus, said treatment formulation is preferably not arranged solely to contact a single large mass of oil within the formation. The oil is preferably not moving along a predetermined, for example man-made, travel path when initially contacted with said treatment formulation.

The treatment formulation may be used after some oil has been removed from the formation by an alternative method.

Initial contact of oil in said formation with said treatment formulation suitably takes place at a position which is at least 5 m, preferably at least 10 m, more preferably at least 50 m, especially at least 100 m, upstream of said production well. Initial contact suitably takes place a distance of at least 10 m, preferably at least 20 m below ground level.

Said treatment formulation may travel at least 10 m, preferably at least 20 m before it contacts oil in said formation.

After initial contact with said treatment formulation, oil may travel at least 10 m, preferably at least 20 m, more preferably at least 50 m prior to reaching said production well.

The subterranean formation which comprises oil to be recovered is suitably a naturally occurring porous medium. Said formation may have a permeability of less than 20 Darcy, suitably less than 10 Darcy. The permeability may be at least 1 milliDarcy, preferably at least 4 milliDarcy. In one embodiment, the permeability may be in the range 1-200 milliDarcy; in another embodiment it may be in the range 0.1 to 10 Darcy, preferably 2 to 6 Darcy.

Before contact with said treatment formulation, the oil in said formation may have a viscosity of at least 10 cP, suitably at least 100 cP, preferably at least 250 cP, more preferably at least 500 cP, when measured at the reservoir temperature of the oil and at a shear rate of 100 s⁻¹. This viscosity may be as high as 200,000 cP or even 10,000,000 cP.

Before contact with said treatment formulation, the oil in said formation may have a viscosity, measured at 25° C. and a shear rate of 100 s¹, of at least 100 cP, suitably at least 200 cP, preferably at least 400 cP, more preferably at least 800 cP, especially at least 1200 cP. In some cases, the viscosity may be greater than 5000 cP, or even 50,000 cP.

The aforementioned viscosities may be measured using an Anton PAAR MCR 300 rheometer equipped with cone and plate sensors.

Said treatment formulation may be introduced into the formation at a pressure of at least 100 Psi. The pressure is preferably less than 10,000 Psi, more preferably less than 5,000 Psi or less than 3,000 Psi.

Said treatment formulation may be at a temperature of at least ambient temperature immediately prior to introduction into the formation. Preferably, said treatment formulation has a temperature in the range 1 to 200° C., preferably 1 to 100° C., immediately prior to said introduction.

Said treatment formulation may be introduced into one injection well associated with the formation at a rate of between 1000 litres/day and 1,000,000 litres/day.

The treatment formulation may be introduced into the formation substantially continuously over a period of at least 1 hour, preferably 12 hours, more preferably 1 day, especially at least 1 week. The aforementioned duration may be up to 6 months, 1 year, 10 years or even 40 years.

The method preferably involves introducing said treatment formulation into said formation via an injection well. In some embodiments, said treatment formulation may be introduced into a plurality, suitably three or more, injection wells, suitably substantially concurrently.

Said injection well may be selected from a vertical well, a deviated well or a horizontal well.

Preferably, initial contact of oil in said formation by said treatment formulation causes oil to move in a first direction (or to increase the speed of movement of oil in the first direction), wherein suitably the oil contacted was not moving in said first direction prior to said initial contact (or was moving at an unacceptably slow speed). Preferably, initial contact of oil in said formation causes the speed of movement of the oil contacted to increase. For example, the oil may be trapped and therefore substantially stationary (except for molecular motion of the oil) prior to contact or the oil may be moving too slowly. After contact, oil may be caused to move and so its speed will be increased. Suitably after contact, oil travels substantially at the speed of said treatment formulation. In some cases, gravity may act on the oil to move it towards the production well in which case oil may move to the production well under both gravity and the force applied by said treatment formulation. In other embodiments, substantially the only force causing oil to move towards the production well may be supplied by said treatment formulation.

Preferably, the treatment formulation is arranged (e.g. by virtue of the pressure applied to it to introduce it into the formation) to carry oil towards the production well.

The subterranean formation may include a plurality of production wells via which oil which has been contacted with said treatment formulation may be collected.

A said production well may be selected from a vertical well, a deviated well, a horizontal well, a multilateral well and a branched well.

Preferably, the viscosity of the treatment formulation is not arranged to increase (except due to a temperature change of the treatment formulation or the treatment formulation becoming associated with oil) during passage of the treatment formulation through the formation. Preferably, the treatment formulation does not form a gel during passage through the formation. Preferably, no means (e.g. chemical) is introduced into the formation to cause the treatment formulation to cross-link and/or form a gel during passage through the formation. Preferably, no component of the treatment formulation cross-links during passage through the formation. Preferably no covalent bonds are formed between molecules in the treatment formulation during passage through the formation.

The material collected in step (ii) suitably comprises oil, water, displacing polymer and dispersing polymer. The respective amounts of oil, water, displacing polymer and dispersing polymer in the material collected will vary over time. Initially, the material collected may include relatively large volumes of oil; subsequently as oil is recovered from the formation its proportion may be reduced. At some stage in the method, the material collected suitably includes greater than 5 wt %, preferably greater than 10 wt %, more preferably greater than 20 wt %, especially greater than 30 wt % of oil. It may include less than 90, 80 or 70 wt % oil.

The material collected in step (ii) may comprise less than 1 wt % of said dispersing polymer.

The material collected in step (ii) may comprise greater than 30 wt %, greater than 40 wt % or greater than 50 wt % of water, and suitably less than 90, 80 or 70 wt % water.

The method may include the step of causing oil to separate from at least part of the displacing polymer and dispersing polymer after collection in step (ii).

Said treatment formulation preferably includes less than 1 wt %, less than 0.5 wt %, less than 0.1 wt %, less than 0.05 wt % of a surfactant. Suitably, the method does not include any surfactant.

Accordingly to a second aspect of the invention, there is provided a treatment formulation comprising a displacing polymer, a dispersing polymer and water.

The treatment formulation, displacing polymer and dispersing polymer may have any feature of the treatment formulation of the first aspect mutatis mutandis.

According to a third aspect of the invention, there is provided apparatus for use in the method of the first aspect the apparatus comprising:

(i) means containing a treatment formulation comprising a displacing polymer and a dispersing polymer;

(ii) means for delivering said treatment formulation to a subterranean formation so that said treatment formulation contacts the subterranean formation;

(iii) means for collecting oil which has been contacted with said treatment formulation.

Any feature of any aspect of any invention or embodiment described herein may be combined with any feature of any aspect of any other invention or embodiment described herein mutatis mutandis.

Specific embodiments of the invention will now be described, by way of example, with reference to the accompanying figures, in which:

FIG. 1 is a schematic representation showing the location of oil in a reservoir pore;

FIG. 2 is a schematic representation of a subterranean formation;

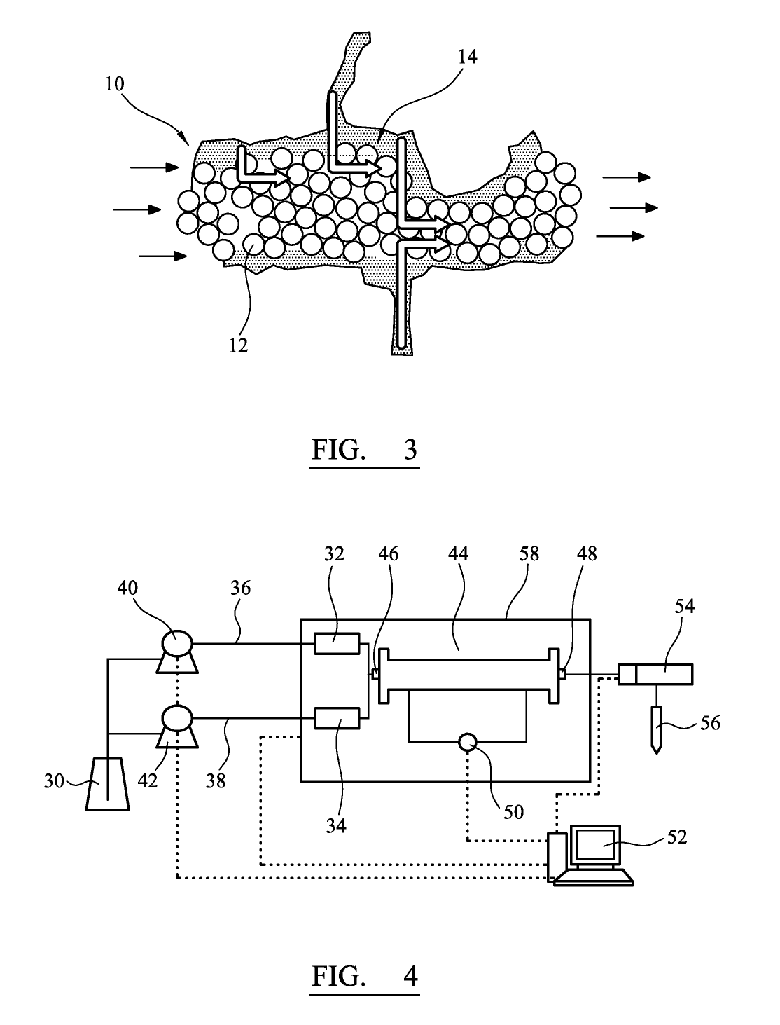

FIG. 3 is the representation of FIG. 1, with a formulation in accordance with a preferred embodiment passing through the reservoir pore;

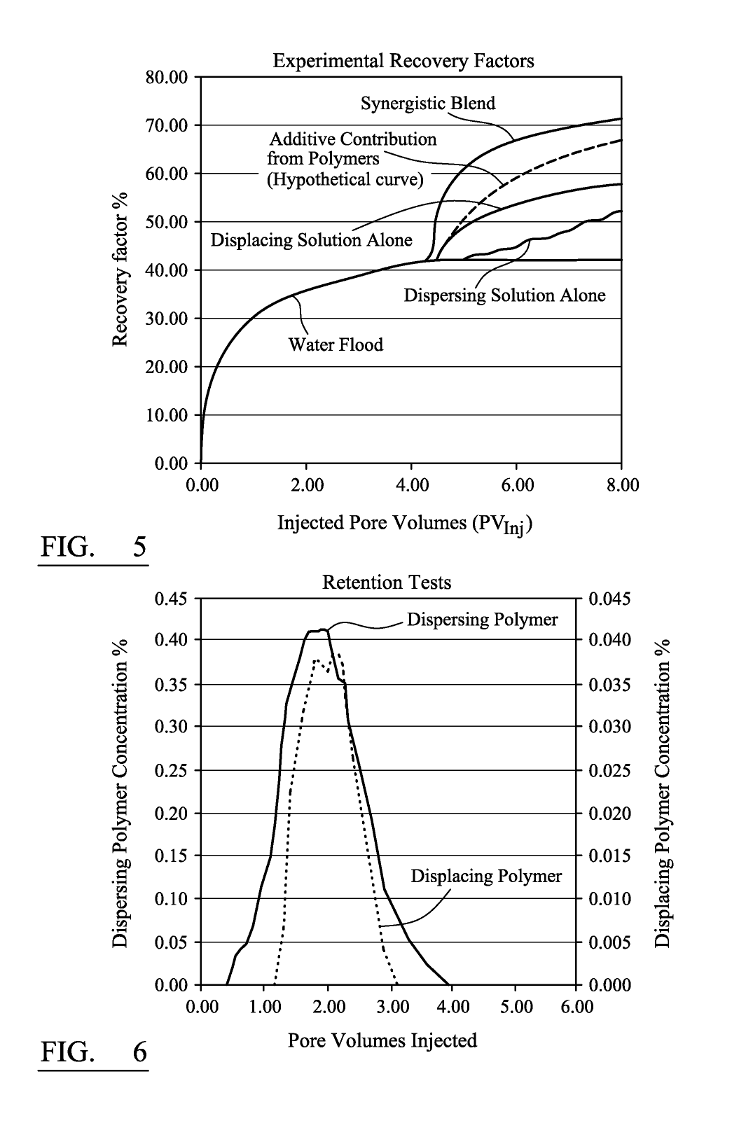

FIG. 4 is a schematic representation of apparatus for undertaking sandpack displacement tests;

FIG. 5 is a graph of Recovery Factors v. Injected Pore Volumes (PVᵢₙⱼ) for specified formulations;

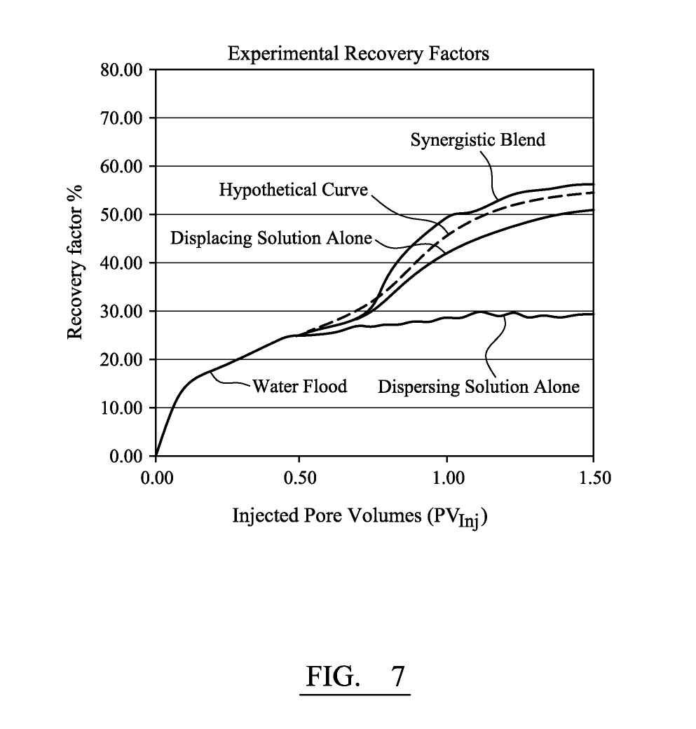

FIGS. 6 and 7 are graphs of Dispersing Polymer Concentration and Displacing Polymer Concentration v. Pore Volumes Injected for two different examples.

The following materials are referred to hereinafter:

Dispersing polymer A—refers to partially hydrolyzed polyvinyl alcohol with a mean molecular weight in the range 13,000 to 23,000 Daltons and a degree of hydrolysis between 88% and 91%. The remaining 11% to 9% are acetyl units.

HPAM—refers to partially hydrolysed polyacrylamide (formula XII above), with a mean molecular weight of 18 million to 22 million Daltons and a degree of hydrolysis between 20 to 30%.

The oil used in the following experiments was a sand-free Canadian heavy oil, dehydrated to a water content of below 0.5 wt %. The oil viscosities at different temperatures were as follows:

| Temp (° C.) | Viscosity CP |
|---|---|
| 10 | 115,200 |
| 20 | 40,010 |
| 25 | 24,800 |
| 30 | 16,400 |
| 40 | 6,300 |
| 50 | 2,850 |
| 60 | 1,300 |

The uncertainty in the viscosities is approximately ±5%. The porosities of all sand packs used were 39.9%±1.5%.

Referring to FIG. 2, a subterranean oil bearing formation 20 includes an injection well 22 which is vertically spaced from a production well 26 with oil bearing formation 28 extending therebetween. The formation 28 may include medium or heavy oil, for example having a API of less than about 30° and/or a viscosity measured at 25° C. in excess of 1000 cP. The formation 20 may have a permeability of for example 1-6 Darcy. Oil in the formation 2 may be present in a number of different forms, as described above with reference to FIG. 1.

To recover oil from the formation 20, a treatment fluid may be injected into the formation via injection well 22 so that it enters the formation as represented by arrows 24. After entering the formation, the treatment fluid will slowly permeate the formation. As it moves, the formulation is able to mobilise oil.

Example 1 hereinafter describes a general method for testing formulations in a sandpack displacement test; Examples 2 to 4 are comparative examples involving different formulations in the test; Example 5 relates to the testing of a formulation in accordance with a preferred embodiment of the invention; Examples 6 and 11 describe the results of sandpack displacement tests; Example 7 assesses chemical retention within a formation; Example 8 assesses interfacial properties; Example 9 assesses treatment solution compatibilities; and Example 10 assesses treatment solution dispersion rheologies.

### EXAMPLE 1

### Sandpack Apparatus

Sandpack displacement tests were carried out using the apparatus of FIG. 4. An injection fluid container 30 for containing a test fluid communicates with respective transfer vessels 32, 34 via respective fluid lines 36, 38 which include respective pumps 40, 42. Downstream of the transfer vessels is a sandpack 44 (66 cm length by 4 cm internal diameter) having an inlet 46 and outlet 48. A pressure transducer is connected between the inlet 46 and outlet 48 to measure the differential pressure across the sandpack during a flooding process and data transmitted to a computer 52. Downstream of outlet 48 is a fluid collector 54 which cooperates with one or more test tubes 56. The computer 52 is connected for transfer of data/signals to pumps 40, 42, transfer vessels 32, 34 and collector 54. The sandpack 44 and vessels 32, 34 are arranged within a thermostatically-controlled oven 58.

The sandpack 44, made from 316 stainless steel, was packed with silica sand using a wet packing method, and the porosity was determined via calculation from the weight of sand used and the sandpack volume. The selected silica sand had a standard mesh size of 100 to 140 (149 microns to 105 microns), a spherical grain shape, a specific gravity of 2.65 g/cm³, and a chemical composition of 98.2% SiO₂ where the major impurities were Al₂O₃ (0.49%) and Fe₂O₃ (0.14%). After packing, four pore volumes of brine were injected into the sandpack held in a vertical orientation in order to flush any residual air from the system and ensure complete brine saturation. The pressure transducer 50 was connected across the injection 46 and production 48 ports in order to determine the brine permeability of the sandpack prior to any flooding experiments. The pressure transducer 50 was used to measure the differential pressure across the sandpack for each flooding process, and this data was continuously recorded using LabView (Trade Mark) software, via computer 52. There was no confining pressure. Injection pump 40, 42 were dual ISCO pumps. A selected pump was used to inject fluids at the appropriate rate, and the pump injection pressure was continuously recorded using LabView software. The input line from the injection pumps 40, 42 to the oven 58 was kept at a constant 25° C. using a re-circulating water bath, while the production line from the oven to the collector 54 was kept at a constant 50° C. using a cable heater. The sandpack and associated transfer vessels were kept at a constant 50° C. inside an oven for the duration of the experiment.

### EXAMPLES 2 TO 5

The formulations described in Table 1 were prepared.

TABLE 1

| Example | |
|---|---|
| No. | Formulation Detail |
| 2 | Brine solution (no polymers) with total dissolved solids |
| | content of 36,000 mg/l, a calcium content of 600 mg/l |
| | and a magnesium content 226 mg/l. |
| 3 | Brine solution of Example 2 with 5000 ppm (0.5 wt %) |
| | of Dispersing polymer A dissolved in it. |
| 4 | Brine solution of Example 2 with 300 ppm (0.03 wt %) |
| | displacing polymer dissolved in it. The formulation had |
| | a viscosity of 10 cP at a shear rate of 1 s⁻¹. The |
| | displacing polymer was HPAM. |
| 5 | Brine solution of Example 2 with 5000 ppm of the dispersing |
| | polymer of Example 3 and 300 ppm of the displacing |
| | polymer of Example 4 dissolved in the brine solution. The |
| | viscosity of the formulation was 10 cP at a shear rate of |
| | 1 s⁻¹. |

### EXAMPLE 6

### Sandpack Displacement Tests (First Method)

The apparatus described in Example 1 was used to test the formulations of Examples 2 to 5 using the following general method:
a. Saturate the pack with the brine of Example 2 and determine initial brine permeability.
b. Displace the brine to completion with a selected oil (by continually injecting the selected oil at 50° C. using the ISCO pumps, until the displaced fluid was absent of any detectable water) and determine total oil volume in pack and permeability to oil at the irreducible brine saturation.
c. Age at 50° C. for a period of 15 days.
d. Displace the oil with the brine of Example 2 to completion, i.e. to the point at which no more oil can be extracted. This is a waterflood stage of the experiment, during which the following data is collected.
   i. Displaced fluid, collected in small volumetric fractions
   ii. Differential pressure across the pack recorded continuously.
e. Determine permeability to brine after displacements are complete.
f. Determine oil and water content of all collected fractions.
g. Determine recovery factors, mobility ratios and residual resistance factors.
h. Construct a plot of recovery factor vs pore volumes of fluid injected (PVᵢₙⱼ).
i. Repeat steps c. to h. using fluids of Examples 3 to 5.

Results

Table 2 details the results—note that, to eliminate inconsistencies between experimental trials, the recovery factor results, after the initial 4 PV of water flood, were normalized to a value of 42.1%, corresponds to the recovery factor at the end of the initial waterflood phase.

| | | | Final Incremental Recovery |
|---|---|---|---|
| Fluid of | Recovery Factor (%) | | Factor |
| Example No. | At 4 PVᵢₙⱼ | At 8 PVᵢₙⱼ | (% over Reference Waterflood) |
| 2 | 42.1 | 42.1 | N/A |
| 3 | 42.1 | 52.4 | 10.3 |
| 4 | 42.1 | 57.9 | 15.8 |
| 5 | 42.1 | 71.0 | 28.9 |

The results are presented graphically in FIG. 5.

The results show the following:
(i) The recovery factor was 71.0% for the Example 5 formulation, which represents an incremental recovery after water flood of 28.9% (Table 2). ((A floodwater baseline is adopted since water flooding is the treatment most commonly used prior to EOR). A water flood baseline is adopted since water flooding is a treatment most commonly used prior to EOR.) With the Example 5 formulation, the incremental recovery is significantly greater than for the dispersing polymer of Example 3 alone (10.3%) or the displacing polymer of Example 4 alone (15.8%).
(ii) The rate of recovery with the Example 5 formulation, immediately after waterflood, was significantly higher than with either the dispersing polymer of Example 3 alone or the displacing polymer of Example 4 alone.
(iii) The formulation of Example 5 has synergistic elements. This can be seen by comparing the recovery curve for the Example 5 formulation with a hypothetical curve (annotated “HYPOTHETICAL CURVE” in FIG. 4) generated from the simple addition of the recovery curves from the dispersing and displacing polymers of Examples 3 and 4 used separately. It is clear that the performance of the Example 5 formulation is more than the sum of its parts.

Although not wishing to be bound by any theory, the results may be interpreted as indicating that the formulation of Example 5 which includes respective polymers with different chemical functions, serves to maximize oil recovery by affecting the oil phase and aqueous phase viscosities as well as the interfacial tension and wettability. This translates into positive changes in the oil phase and aqueous phase mobilities as well as capillary number that help to increase oil recovery efficiency. In addition to these changes, a reduction in the displaced phase viscosity would increase the sweep efficiency by reducing small-scale viscous instabilities which are commonly encountered when there is a large viscosity contrast between the displaced fluid and the displacing fluid. Table 3 shows calculated mobility ratios and residual resistance factors for the fluids of Examples 2 to 5, supporting the above theory.

TABLE 3

| Fluid of Example No. | Mobility Ratios | Residual Resistance Factors |
|---|---|---|
| 2 | 8.46 | N/A |
| 3 | 2.92 | 1.28 |
| 4 | 0.7 | 0.86 |
| 5 | 0.27 | 1.08 |

### EXAMPLE 7

### Assessment of Chemical Retention

In a tertiary treatment (e.g. Enhanced Oil Recovery) it is important that the retention of any chemical within the subterranean formation is minimal, in order that loss of chemical to the formation is minimized and that the performance of the system is not impaired. This may be particularly important with formulations used in preferred embodiments of the present invention, where it is anticipated that synergy will be maximized when both dispersing and displacing polymers travel through the formation together. Therefore, it is preferred that there should be no significant chromatographic separation of the polymers.

Chemical analysis of the multiple fractions collected from the sandpack tests allows the relative retention of the polymers to be calculated. FIG. 6 is a plot of the two polymer concentrations (expressed as a fraction of their injected concentration) as a function of injected pore volumes. It is clear that the two polymers travel through the sandpack at almost identical rates. By comparison, we would expect that, if a regular anionic surfactant was used instead of the dispersing polymer, its retention would be severe and its profile would be shifted to the far right of the plot, well away from the profile of the displacing polymer.

Whilst not wishing to be bound by any theory, it is believed that the formulations described function as represented in FIG. 3. In the figure, arrows 10 represent the direction of flow of formulation through the pore. Reference 12 represents a highly mobile oil dispersion created by the dispersing polymer and the dispersion is pushed by the displacing polymer. Reference 14 represents irreducible oil being “pulled” and “stripped” away by the combined effect of the dispersing and displacing polymers.

Various tests were undertaken to facilitate selection of other appropriate dispersing and displacing polymers, based on applicant's theory and understanding. Example 8 assesses interfacial properties of dispersing polymers which have been found to be important in preparing advantageous formulations. Example 9 assesses treatment solution compatibilities to assess whether the preferred dispersing polymer changes the rheological properties of potential displacing polymers. Example 10 assesses whether the preferred dispersing polymer is still able to disperse crude oils when in the presence of displacing polymers.

### EXAMPLE 8

### Interfacial Properties of Dispersions Made from Dispersing Polymers Alone

The objective was to measure interfacial properties of optional dispersing polymers in order to select a dispersing polymer that has the greatest tendency to increase the capillary number (the ratio of viscous forces to capillary forces in flow through a capillary) by reducing interfacial tension.

All solutions tested were composed of the dispersing polymer at a concentration of 0.5% by weight in tap water. Surface and interfacial tensions were determined using drop shape analysis, with a Kruss DSA 100.

Results are provided in Table 4, with reference to the following generic structure:

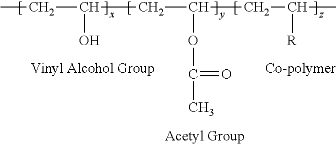

TABLE 4

| | | | | | | Interfacial Tension of | |
|---|---|---|---|---|---|---|---|
| | | | | | | Two Different Oils | |
| | Surface | | | | Approximate | Oil Visosity | Oil Viscosity |
| | Tension | Hydrolysis % | | z % | Molecular | 37,500 cP at | 71,000 cP at |
| Dispersing Polymer | mN/m | 100 x/(x + y) | R | 100 z/(x + y + z) | Weight | 25 C. | 25 C. |
| Polyvinyl Alcohol | 65.46 | 99.5 | None | 0 | 130,000 | 20.88 | 18.75 |
| Polyvinyl Alcohol | 48.7 | 88.6 | None | 0 | 20,000 | 9.32 | 9.15 |
| Polyvinyl Alcohol | 55.94 | 80 | None | 0 | 170,000 | 17.83 | 14 |
| Polyvinyl Alcohol | 49 | 89 | None | 0 | 180,000 | 9.66 | 9.8 |
| Polyvinyl Alcohol - | 52.92 | 98.4 | N-vinyl | 6 | 35,000 | 11.99 | 13.42 |
| vinyl formamide copolymer | | | formamide | | | | |
| Polyvinyl Alcohol - | 66.91 | 98.4 | N-vinyl | 6 | 105,000 | 11.51 | 13.27 |
| vinyl formamide copolymer | | | formamide | | | | |
| Polyvinyl Alcohol - | 68.59 | 99 | N-vinyl amine | 6 | 25000-50,000 | 2.26 | 5.66 |
| vinyl amine copolymer | | | | | | | |
| Polyvinyl Alcohol - | 68.51 | 99 | N-vinyl amine | 6 | 105,000 | 2.35 | 5.77 |
| vinyl amine copolymer | | | | | | | |
| Hydrophobically modified | 46.94 | 90.3 | C8/C9 Alkyl | 0.8 | <20,000 | 7.68 | 7.76 |
| Polyvinyl Alcohol | | | groups | | | | |
| Hydrophobically modified | 56.22 | 98.8 | C8/C9 Alkyl | 0.8 | <20,000 | 11.84 | 11.91 |
| Polyvinyl Alcohol | | | groups | | | | |
| Hydrophobically modified | 45.51 | 90 | C8/C9 Alkyl | 1.2 | <20,000 | 6.69 | 6.89 |
| Polyvinyl Alcohol | | | groups | | | | |
| Hydrophobically modified | 42.12 | 89.6 | C8/C9 Alkyl | 0.9 | <20,000 | 9.81 | 9.89 |
| Polyvinyl Alcohol | | | groups | | | | |
| Polyvinyl Alcohol | 47.52 | 88 | None | 0 | 18,000 | 6.87 | 8.2 |
| Polyinyl Alcohol - | 55.61 | 88 | sulphonate/ | <5 | 15,000 | 12.26 | 12.13 |
| sulphonated co-polymer | | | sulphonic acid | | | | |

From the detail in Table 4, it appears that all dispersing polymers tested would have some ability to water wet silica surfaces and also increase capillary number.

### EXAMPLE 9

### Treatment Solution Compatibilities

The tests involved first creating solutions, containing optional displacing polymers, in tap water and then determining their steady shear rheograms, at 22° C., in the presence or absence of the preferred dispersing polymer. Rheological measurements were made using a Brookfield LVDV II + Pro viscometer. Measurements were made in duplicate.

Detail on experiments undertaken and results are provided in Table 5. In each case, the dispersing polymer was 99.6% hydrolysed polyvinylalcohol of 20,000 molecular weight (referred to as “PVOH 20K”).

TABLE 5

| Formulation assessed | Comparison material | Comments |
|---|---|---|
| a) 350 ppm HPAM + 5000 ppm | 350 ppm HPAM | The rheograms for the |
| PVOH 20K | | formulation assessed and |
| | | comparison material were |
| | | found to be substantially |
| | | identical. |
| b) 500 ppm Diutan + 5000 ppm | 500 ppm Diutan | The rheograms for the |
| PVOH 20K | | formulation assessed and |
| | | comparison material were |
| | | found to be substantially |
| | | identical. |
| c) 350 ppm Diutan + 350 ppm | 350 ppm Diutan + 350 ppm | The rheograms for the |
| HPAM + 1000 ppm PVOH 20K | HPAM | formulation assessed and |
| | | comparison material were |
| | | found to be substantially |
| | | identical. |
| d) 450 ppm Xanthan + | 450 ppm Xanthan | The rheograms for the |
| 5000 ppm PVOH 20K | | formulation assessed and |
| | | comparison material were |
| | | found to be substantially |
| | | identical. |

It is clear from the above that there is little impact of the preferred dispersing polymer on the rheologies of the potential displacing polymer.

### EXAMPLE 10

### Treatment Solution Dispersion Rheologies

A treatment fluid was composed of 500 ppm (0.5 wt %) PVOH 20K and 300 ppm (0.03 wt %) of HPAM in tap water (<100 ppm dissolved solids) and oil rheology was determined by cone and plate geometry using Anton PAAR MCR 300. Rheograms constructed clearly demonstrate that the treatment fluid was able to reduce the viscosity of a number of oils.

The experiment was repeated using a brine carrier fluid with a total dissolved solids content of 36,000 mg/l, a calcium content of 600 mg/l and a magnesium content of 226 mg/l. Dispersion rheograms with oil were constructed. It was found that the effect of brine is to reduce the viscosity at all shear rates which is believed to be due to the brine components causing the hydrodynamic volume of the dispersing polymer chains to shrink.

### EXAMPLE 11

### Sand Pack Displacement Tests (Second Method)

A procedure similar to that in Example 6 was undertaken using the same formulations except that in Example 6 the waterflood stage was continued until no more oil could be displaced (approximately 4 pore volumes) and at this point the selected treatment fluid was injected for a further 4 pore volumes; whereas in the present example the waterflood stage was limited to only 0.5 pore volumes and the subsequent treatments were reduced to 1 pore volume, making the total volume injected 1.5 pore volumes. The objective was to assess the tendency for synergy using vastly reduced quantities of chemicals. Results are provided in FIG. 7 which show the same characteristics as in FIG. 5 (for Example 6)—that is, the recovery factors for the synergistic blend are highest after 1.5 pore volumes and the performance of the synergistic blend is beyond that defined by the hypothetical curve.

It should now be appreciated that a formulation comprising a dispersing polymer (e.g. polyvinylalcohol) and a displacing polymer (e.g. HPAM) act synergistically to improve in the macroscopic sweep efficiency of a treatment and simultaneously improve the microscopic displacement efficiency. To achieve performance benefits, the components of the formulation are suitably chemically compatible and work together to produce a result not obtainable by using single components alone, i.e. the performance of a preferred formulation is more than the sum of its parts.

The sweep efficiency will be increased, by decreasing the mobility ratio. In addition, the formation of a low viscosity dispersion within a pore will minimize the viscosity difference between the displacing fluid and the displaced fluid, thereby minimizing viscous fingering caused by small scale instabilities. In addition, the displacement efficiency will be increased as a consequence of the increase in the capillary number. This effect is directly related to the increase in the viscosity of the displacing phase and inversely related to the reduction in the interfacial tension. The viscoelastic properties of the displacing polymer solution will also facilitate an increase in the displacement efficiency.

The residual resistance factor will be lower than that achievable with polymer solutions alone, preferably less than 1.3, most preferably less than 1.2. Applicant believes this is achieved as a consequence of the reduced adsorption, and reduced mechanical entrapment, of the displacing polymer in the presence of the water wetting dispersing polymer. In addition, the retention of the displacing and dispersing polymers should be similar, i.e. the chromatographic separation of the polymers should be minimal, and far less than if the dispersing polymer was a conventional surfactant. Having similar levels of polymer retention leads to a reduction in the tendency of the injected fluid to ‘loose’ one of its synergistic components.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of recovering oil from a subterranean formation, the method including the step of:
(a) contacting the subterranean formation with a treatment formulation comprising a displacing polymer and a dispersing polymer; and
(b) collecting oil which has been contacted with said treatment formulation via a production well.

2. A method according to claim 1, wherein said displacing polymer is such that a test formulation comprising 500 ppm of said displacing polymer dissolved in deionized water, in the absence of any other additives, has a viscosity when measured at 25° C. and 1 s⁻¹ in the range 5 cP to 100 cP and the following first relationship applies, when viscosity is measured as aforesaid:
$$\frac{Viscosity of test formulation at {30}^{∘} C}{Viscosity of test formulation at {20}^{∘} C} >= 0.6$$
and the following second relationship applies, when the viscosity is measured as aforesaid:
$$\frac{Viscosity of test formulation at {80}^{∘} C}{Viscosity of test formulation at {20}^{∘} C} >= 0.10$$

3. A method according to claim 1, wherein the viscosity of the treatment formulation divided by the viscosity of a formulation that is the same as said treatment formulation except that it does not include the dispersing polymer, when the viscosities are measured at 25° C. and 1 s⁻¹, is in the range 0.6 to 1.3.

4. A method according to claim 1, wherein said displacing polymer has a molecular weight of at least 200,000 Daltons and a molecular weight of less than 35,000,000 Daltons.

5. A method according to claim 1, wherein said displacing polymer is selected from poly(vinylalcohol), acrylic acid-based, acrylamide-based and vinylpyridine-based polymers, poly(methylvinylether), polyvinylpyrrolidone, polyethylene oxide, cellulose, polysaccharides, biopolymers, scleroglucan, xanthan and derivatives of the aforesaid.

6. A method according to claim 1, wherein said displacing polymer includes at least two different repeat units, wherein said at least two different repeat units include functional groups selected from amide, carboxy, hydroxy and ether groups.

7. A method according to claim 1, wherein said displacing polymer includes a repeat unit which includes an acrylamide of formula

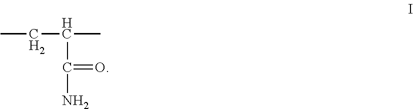

8. A method according to claim 7, wherein said displacing polymer includes a repeat unit of formula I in combination with a repeat unit comprising a moiety 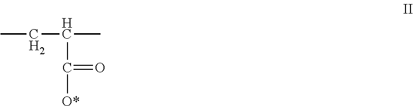
wherein the O* moiety is an O⁻ moiety or is covalently bonded to another atom or group.

9. A method according to claim 7, wherein said displacing polymer includes a repeat unit of formula I in combination with a repeat unit comprising a moiety 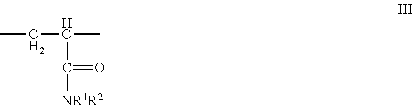
wherein R¹ and R² are independently selected from a hydrogen atom and an optionally-substituted alkyl group.

10. A method according to claim 9, wherein said moiety III is of formula 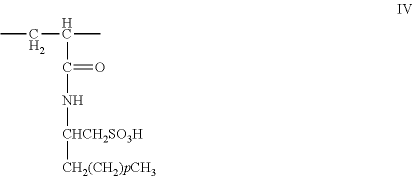
wherein p is an integer in the range 0 to 10; or said moiety III is of formula

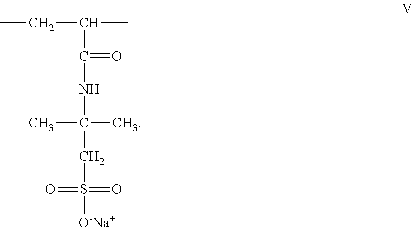

11. A method according to claim 1, wherein said displacing polymer is a hydrophobically modified polyacrylamide or an acrylamidomethyl propane sulphonate (AMPS).

12. A method according to claim 1, wherein said displacing polymer is of formula 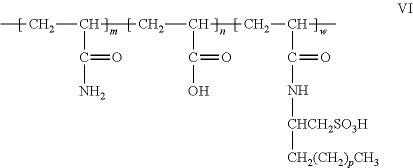
wherein m, n and w represent the average number of respective repeat units and p is an integer in the range 0 to 10; or of formula

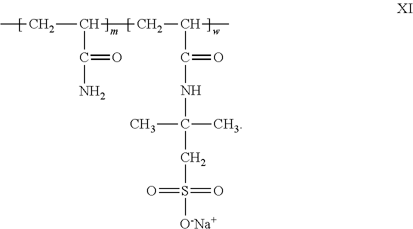

13. A method according to claim 1, wherein said treatment formulation includes less than 8000 ppm and at least 25 ppm of said displacing polymer.

14. (canceled)

15. A method according to claim 1, wherein an oil dispersion comprising oil from the subterranean formation and an aqueous formulation of dispersing polymer, containing 5000 ppm of dispersing polymer, at an oil:aqueous formulation ratio of 70:30, have the following characteristics at 25° C.:
viscosity, at a shear rate of 1 s⁻¹, of less than 4000 cP;
pseudoplasticity over the shear rate range 1 s⁻¹ to 100 s⁻¹;
viscosity, at a shear rate of 100 s⁻¹, of no more than 600 cP.

16. (canceled)

17. A method according to claim 1, wherein said dispersing polymer includes, on average, at least 10 —O— moieties pendent from a polymeric backbone.

18. A method according to claim 1, wherein said dispersing polymer includes a moiety:

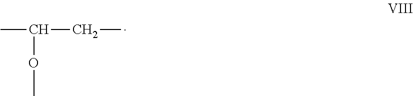

19. (canceled)

20. (canceled)

21. A method according to claim 18, wherein the free bond to the oxygen atom in moiety VIII is bonded to a group R¹⁰, wherein moiety —O—R¹⁰ is an hydroxyl or acetate group.

22. (canceled)

23. (canceled)

24. A method according to claim 1, wherein the dispersing polymer includes acetate groups and hydroxyl groups and the ratio of the number of acetate groups to the number of hydroxyl groups in said dispersing polymer is in the range 0.06 to 0.3.

25. A method according to claim 18, wherein each free bond to the oxygen atoms in —O— moieties pendent from the polymeric backbone in said dispersing polymer is of formula —O—R¹⁰ wherein each group —OR¹⁰ is selected from hydroxyl and acetate.

26. A method according to claim 1, wherein said dispersing polymer comprises at least 70 mole % of vinylalcohol repeat units and 30 mole % or less of vinylacetate repeat units.

27. A method according claim 1, wherein said dispersing polymer comprises 80 to 95% hydrolysed polyvinylalcohol.

28. A method according to claim 1, wherein the weight average molecular weight of said dispersing polymer is in the range 5,000 to 50,000 and/or the viscosity of a 4 wt % aqueous solution of the dispersing polymer at 20° C. is in the range 2 to 4 cP.

29. (canceled)

30. A method according to claim 1, wherein said treatment formulation includes:
100 ppm to 30000 ppm displacing polymer
500 ppm to 10000 ppm dispersing polymer.

31. A method according to claim 1, wherein said displacing polymer includes an acrylamide repeat unit and said dispersing polymer includes vinylalcohol and vinylacetate repeat units.

32. (canceled)

33. A method according to claim 1, wherein the treatment formulation includes less than 0.1 wt % of a surfactant.

34. A treatment formulation comprising a displacing polymer, a dispersing polymer and water wherein said displacing polymer includes an acrylamide repeat unit and said dispersing polymer includes vinylalcohol and vinylacetate repeat units, said treatment formulation includes:
100 ppm to 30000 ppm displacing polymer
500 ppm to 10000 ppm dispersing polymer.

35. Apparatus for use in recovering oil from a subterranean formation, the apparatus comprising:
(i) means containing a treatment formulation as claimed in claim 34;
(ii) means for delivering said treatment formulation to a subterranean formation so that said treatment formulation contacts the subterranean formation;
(iii) means for collecting oil which has been contacted with said treatment formulation.

36. A method according to claim 1, wherein said displacing polymer has a molecular weight of at least 200,000 Daltons and a molecular weight of less than 35,000,000 Daltons, said displacing polymer includes an acrylamide repeat unit and said dispersing polymer comprises 80 to 95% hydrolysed polyvinylalcohol, wherein said treatment formulation includes:
100 ppm to 30000 ppm displacing polymer
500 ppm to 10000 ppm dispersing polymer.
